(19) United States
(12) Patent Application Publication
(10) Pub. No.: US 2015/0180874 A1
(43) Pub. Date: Jun. 25, 2015

(54) ELECTRONIC DEVICE, METHOD, AND COMPUTER PROGRAM PRODUCT

(71) Applicant: Kabushiki Kaisha Toshiba, Tokyo (JP)

(72) Inventor: Takuya OOTANI, Ome-shi (JP)

(21) Appl. No.: 14/445,613

(22) Filed: Jul. 29, 2014

(30) Foreign Application Priority Data
Dec. 25, 2013 (JP) 2013-267783

(51) Int. Cl. H04L 29/06

(52) U.S. Cl. CPC H04L 63/10

(57) ABSTRACT

According to one embodiment, an electronic device includes communication controller and controller. The electronic device is for a first user and a second user configured to allow logging into an operating system. The communication controller connects to one of a first network and a second network, and communicates through a connected one of the first network and the second network. The controller enables a login of the first user and disables a login of the second user while the communication controller is connected to the first network. The controller enables a login of the second user and disables a login of the first user while the communication controller is connected to the second network. The controller sets the electronic device to be usable by one of the first user logged in and the second user logged in.

### CROSS-REFERENCE TO RELATED APPLICATIONS

This application is based upon and claims the benefit of priority from Japanese Patent Application No. 2013-267783, filed Dec. 25, 2013, the entire contents of which are incorporated herein by reference.

### FIELD

Embodiments described herein relate generally to an electronic device, a method, and a computer program product.

### BACKGROUND

Recently, there has been considered to adopt Bring Your Own Device (BYOD) in order for companies to reduce costs such as terminal purchasing costs and communication costs and in order for employees to perform tasks with accustomed terminals without requiring to have two same kind of terminals.

In such case, in order to ensure security similar to a case in which a company provides terminals, there has been proposed a technique that can create an account for business and an account for private use on a terminal and that disables reference to information of a different account. Also there has been developed a technique that controls a terminal in accordance with current conditions such as the location of the terminal and time.

However, it is difficult for the conventional technologies to appropriately protect information of a user in accordance with connectable networks.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary explanatory diagram of a network connection of a portable terminal according to a first embodiment;

FIG. 2 is an exemplary diagram of a hardware configuration of the portable terminal in the first embodiment;

FIG. 3 is an exemplary diagram of blocks of a software configuration of the portable terminal in the first embodiment;

FIG. 4 is an exemplary diagram of a table structure of a user group list holding module in the first embodiment;

FIG. 5 is an exemplary diagram of a table structure of a network group list holding module in the first embodiment;

FIG. 6 is an exemplary diagram of a login screen of the portable terminal in the first embodiment;

FIG. 7 is an exemplary diagram of a network switching window before login of the portable terminal in the first embodiment;

FIG. 8 is an exemplary diagram of a login screen when the portable terminal has connected to the public line, in the first embodiment;

FIG. 9 is an exemplary diagram of a network connection setting screen displayed on a display by a display controller of the portable terminal in the first embodiment;

FIG. 10 is an exemplary diagram of a user account setting screen displayed on the display by the display controller of the portable terminal in the first embodiment;

FIG. 11 is an exemplary flowchart of network switching processing of the portable terminal while a user has been logged in, in the first embodiment; and

FIG. 12 is an exemplary flowchart illustrating a procedure of network switching processing of the portable terminal in the first embodiment while a user logs in.

### DETAILED DESCRIPTION

In general, according to one embodiment, an electronic device is for a first user and a second user configured to allow logging into an operating system. The electronic device comprises a communication controller and a controller. The communication controller is configured to connect to one of a first network and a second network, and to communicate through a connected one of the first network and the second network. The controller is configured to enable a login of the first user and to disable a login of the second user while the communication controller is connected to the first network. The controller is configured to enable a login of the second user and disable a login of the first user while the communication controller is connected to the second network. The controller is configured to set the electronic device to be usable by one of the first user logged in and the second user logged in.

The following embodiments describe examples in which an electronic device is adopted to portable terminals such as a tablet terminal. The electronic device is not limited to portable terminals and may be adopted to other electronic devices such as cellular phone terminals, smartphones, and PCs.

### First Embodiment

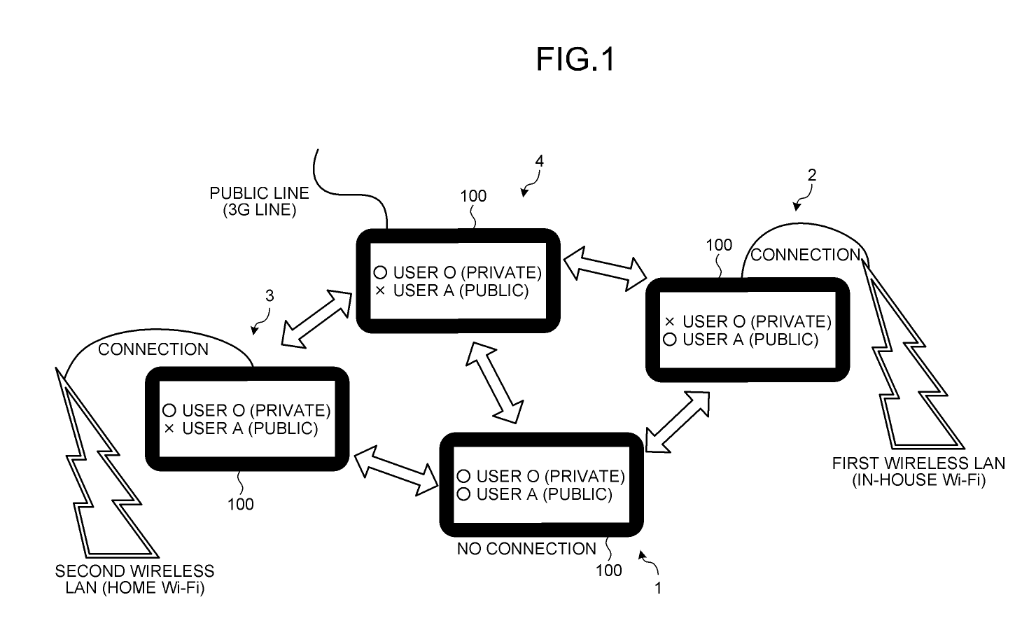

FIG. 1 is an explanatory diagram illustrating an example of a network connection of a portable terminal according to a first embodiment. The example illustrated in FIG. 1 enables any one of a plurality of users (a user O and a user A) to log into this portable terminal 100. FIG. 1 illustrates that a user who is permitted to login varies in accordance with a network currently connected.

The portable terminal 100 may be, for example, an Android tablet version 4.2 or later. The version 4.2 or later provides a multiuser function. As a result, the portable terminal 100 according to the present embodiment can set a plurality of accounts.

The portable terminal 100 according to the present embodiment can further set a public account or a private account for each settable account. In other words, the public account is created for business use, and is used when the portable terminal 110 is used in a working environment. The private account is an account for private use, and is used when the portable terminal 100 is used in a home environment. Thus, the portable terminal 100 according to the present embodiment achieves Bring Your Own Device (BYOD) owing to the multiuser function.

Even when the public account and the private account are thus separated, a login with the public user account in spite of a home environment or a login with the private user account in spite of a working environment due to human error may cause a security risk. Given this situation, the present embodiment performs control so as to be unconnectable to a network provided in a home environment with the public account and to be unconnectable to a network provided in a working environment with the private account.

For example, in an example illustrated in reference numeral 1000 of FIG. 1, when the portable terminal 100 is not connecting to any network, the portable terminal 100 enables the user O as a private user and the user A as a public user to be logged in. When connecting to a first wireless LAN as in-house Wi-Fi as in an example illustrated in reference numeral 2000, the portable terminal 100 disables the user O as the private user to be logged in and enables the user A as the public user to be logged in.

When connecting to a second wireless LAN as home Wi-Fi as in an example illustrated in reference numeral 3000 or a user-contracted public line (a 3G line) as in an example illustrated in reference numeral 4000, the portable terminal 100 performs control so as to enable the user O as the private user to be logged in and to disable the user A as the public user to be logged in.

By performing the above control, network connection appropriate for a logged-in user can prevent human error, protect information of each account, and improve security. The communication line to connect is not limited to the above lines and may be any communication line to which the portable terminal 100 can connect.

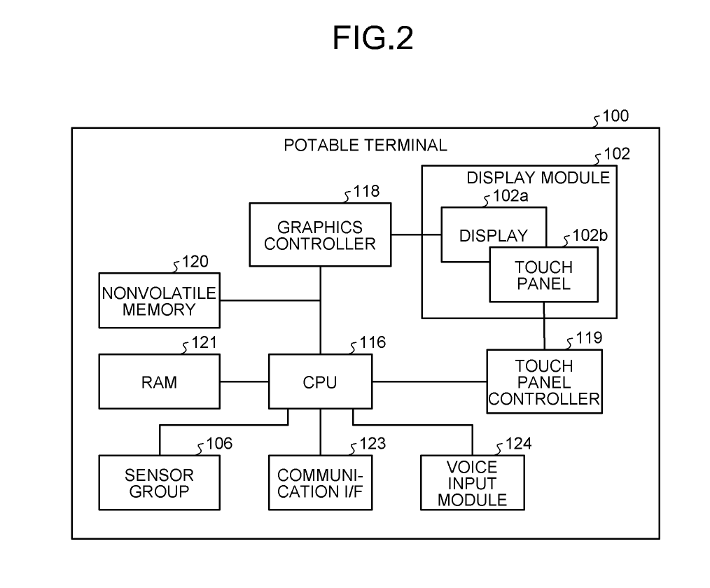

FIG. 2 is a diagram illustrating an example of a hardware configuration of the portable terminal 100 in the present embodiment. As illustrated in FIG. 2, the portable terminal 100 comprises a display module 102, a central processing unit (CPU) 116, a graphics controller 118, a touch panel controller 119, a nonvolatile memory 120, a random access memory (RAM) 121, a communication interface (I/F) 123, a sensor group 106, and a voice input module 124. The portable terminal 100 may further comprise a camera and a speaker. The voice input module 124 is a voice input device such as a microphone.

The display module 102 is configured as what is called a touch screen as a combination of a display 102a and a touch panel 102b. The display 102a is, for example, a liquid crystal display (LCD) or an electro luminescence (EL) display. The touch panel 102b detects a position (a touch position) on a display screen of the display 102a touched with a finger of a user or a stylus pen.

The nonvolatile memory 120 stores therein an operating system (OS), various application programs, various data necessary for the execution of the programs, and the like. The CPU 116 is a processor that controls the operation of the portable terminal 100 and controls the components of the portable terminal 100.

The CPU 116 executes the operating system and the various applications loaded from the nonvolatile memory 120 to the RAM 121, and achieves various functions. The RAM 121, as a main memory of the portable terminal 100, provides a working area when the CPU 116 executes a program.

The graphics controller 118 is a display controller that controls the display 102a of the display module 102. The touch panel controller 119 controls the touch panel 102b and acquires coordinate data indicating a touch position by a user from the touch panel 102b.

The communication I/F 123 is an interface for connection to networks such as a public line and a wireless communication line under the control of the CPU 116. The communication I/F 123 connects to one of a plurality of communication networks comprising the public line and the wireless LANs, and enables communication through the connected network.

The sensor group 106 comprises: an acceleration sensor that detects the direction and magnitude of external acceleration to the portable terminal 100; an orientation sensor that detects the orientation of the portable terminal 100; and a gyro sensor that detects the angular acceleration (rotational angle) of the portable terminal 100.

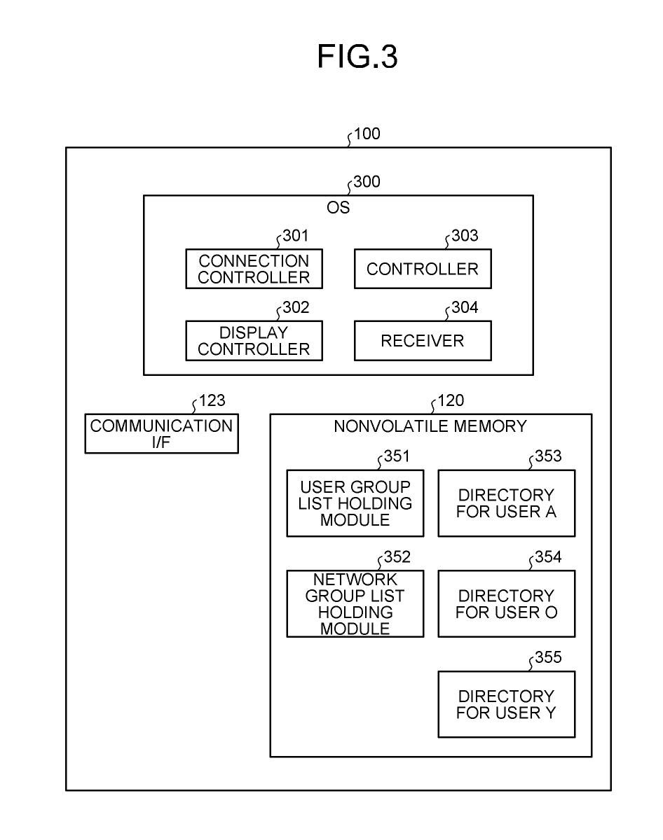

FIG. 3 is a diagram exemplifying blocks of a software configuration of the portable terminal 100 in the present embodiment. As illustrated in FIG. 3, the CPU 116 of the portable terminal 100 loads an OS 300 from the nonvolatile memory 120 to the RAM 121 at startup and executes it, thereby realizes a connection controller 301, a display controller 302, a controller 303, and a receiver 304 as partial components of the OS 300. Executing the OS 300 in the portable terminal 100 enables a user to log into the OS 300.

Directories for respective user accounts are prepared in the nonvolatile memory 120. The present embodiment registers the accounts of the user A, the user O, and a user Y in the portable terminal 100.

For that purpose, the nonvolatile memory 120 comprises a directory 353 for user A, a directory 354 for user O, and a directory 355 for user Y. The OS 300 according to the present embodiment mounts one of these directories in accordance with the user account that has logged in, thereby constructing an environment appropriate for the user who has logged in. Disabling the user who has logged in to refer to the other users' directories can protect the other users' information.

The nonvolatile memory 120 further comprises a user group list holding module 351 and a network group list holding module 352.

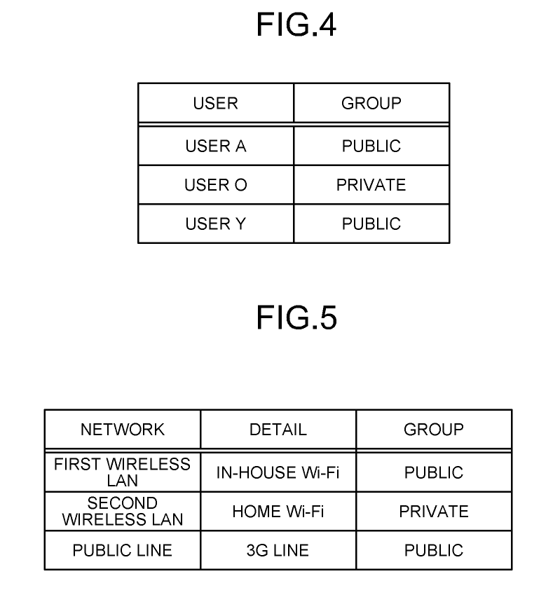

The user group list holding module 351 holds groups set for users, respectively. The group of the user group list holding module 351 is an attribute that identifies whether a user account is a private account or a public account in order to identify a connectable network. FIG. 4 is a diagram illustrating a table structure example of the user group list holding module 351. As illustrated in FIG. 4, the user group list holding module 351 associates users and groups with each other. In this way, the user group list holding module 351 sets the public account or the private account for each user account.

The network group list holding module 352 holds groups set for networks, respectively. The group of the network group list holding module 352 is an attribute that identifies whether a network is a private network or a public network in order to identify whether a user can connect thereto. FIG. 5 is a diagram illustrating an example of a table structure of the network group list holding module 352. As illustrated in FIG. 5, the network group list holding module 352 associates networks, details, and groups with each other. The detail indicates the description of each network. In this way, the network group list holding module 352 sets the public network or the private network for each network.

The OS 300 according to the present embodiment refers to the user group list holding module 351 and the network group list holding module 352, and determines a network to which each user can log in. In other words, the private account is enabled to log into only the private network, whereas the public account is enabled to log into only the public network. Described next are components of the OS 300.

The connection controller 301 connects to a network using the communication I/F 123 to control transmission and reception of data. For example, the connection controller 301 connects to one network among a plurality of networks whose signals are currently detected (in other words, that are currently connectable) and performs communication control through the connected network.

The display controller 302 performs control to display information on the display 102a of the display module 102.

The controller 303 performs various control of the portable terminal 100 and performs user login control, for example.

The receiver 304 receives operations on the touch panel 102b through the touch panel controller 119.

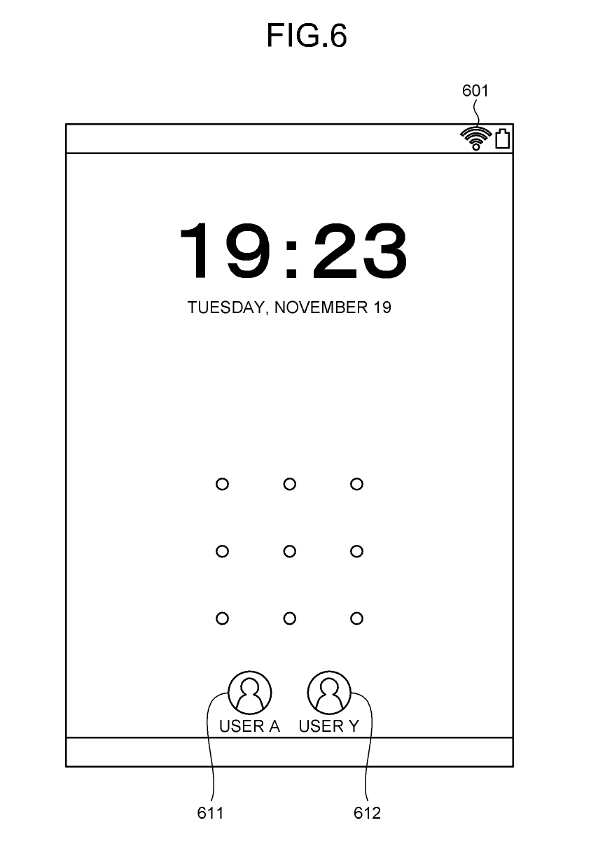

FIG. 6 is a diagram illustrating an example of a login screen of the portable terminal 100 according to the present embodiment. In the example illustrated in FIG. 6, because a network connection symbol 601 is displayed, connection to a network can be recognized. In the example illustrated in FIG. 6, it is assumed that the connection controller 301 is performing control to connect to the first wireless LAN (in-house Wi-Fi) using the communication I/F 123. In this way, while the communication I/F 123 connects to the first wireless LAN (in-house Wi-Fi), the controller 303 enables a login by the user A and the user Y, which are the public accounts, and disables a login by the user O. For example, the display controller 302 only displays an icon 611 indicating the user A and an icon 612 indicating the user Y, which are the public accounts, in accordance with the control from the controller 303. This enables receipt of a login only by the user A and the user Y.

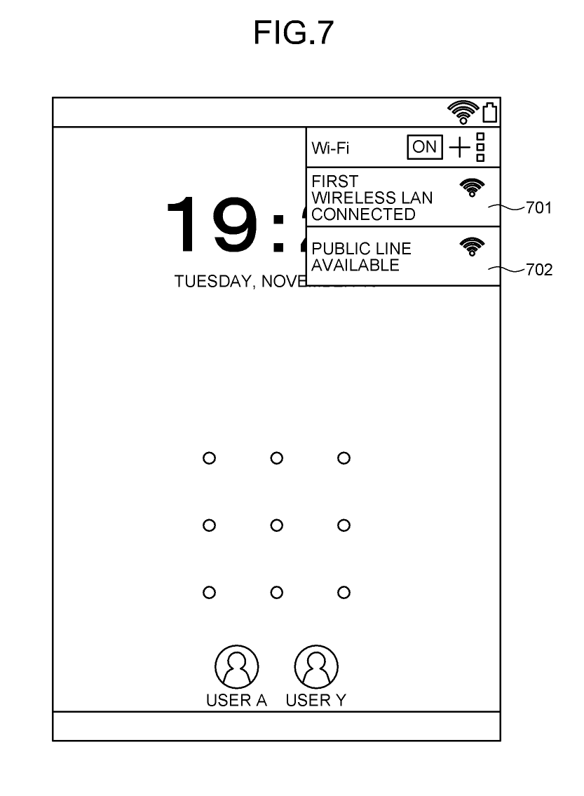

A network to connect may be switched on a login screen (before a user logs in) of the portable terminal 100 according to the present embodiment. Upon receipt of a touch on the network connection symbol 601 by the receiver 304, the display controller 302 displays a network switching window. FIG. 7 is a diagram exemplifying a network switching window before the portable terminal 100 is logged in, according to the present embodiment. As illustrated in FIG. 7, displayed on the switching window are, as connectable networks: a first wireless LAN selection item 701 (as the public network) that is connectable while the user A or the user Y is logged in; and a public line selection item 702 (as the private network) that is communicable while the user O is logged in. The receiver 304 receives a selection of a network connected by the communication I/F 123 from the first wireless LAN and the public line.

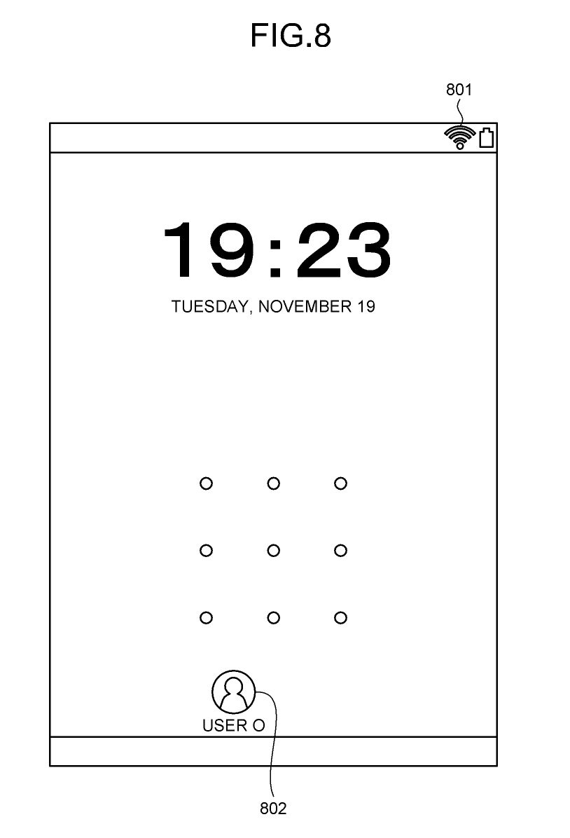

Upon receipt of the selection of the network by the receiver 304, the display controller 302 displays a login screen for a user corresponding to the selected network. FIG. 8 is a diagram illustrating an example of a login screen of the portable terminal 100 according to the present embodiment when a public line is selected. In the example illustrated in FIG. 8, because a network connection symbol 801 is displayed, connection to a network can be recognized. The example illustrated in FIG. 8 displays only an icon 802 indicating the user O who can log into the public line (as the private network).

The portable terminal 100 according to the present embodiment enables receipt of a login of only a limited user corresponding to the connected network, and enables switching of a network to connect by performing the above control on the login screen, thereby enables a login of a desired user.

While a user has been logged into the OS 300, the controller 303 performs control so as to enable the use of the electronic device by the user within a scope permitted by authority given to the user. A control method for enabling the use of the electronic device varies by OS and is not limited in particular.

After the user is logged in, the display controller 302 can display a network connection screen through which a network to connect is switched in accordance with an operation by the user. The display controller 302 displays only a list of networks to which connection by a user account currently being logged in is permitted, among networks whose signals are currently detected (in other words, that are currently connectable) on the network connection screen. In other words, when the portable terminal 100 is logged in with the private user account, the display controller 302 displays only a list of networks belonging to a group of private networks among the networks whose signals are currently detected. Similarly, when the portable terminal 100 is logged in with the public user account, the display controller 302 displays only a list of networks belonging to a group of public networks among the networks whose signals are currently detected.

Thus, the controller 303 performs control so as to be connectable to the public network by the communication I/F 123 and to be unconnectable to the private network while the portable terminal 100 is logged in with the public user account. Further, the controller 303 performs control so as to be connectable to the private network by the communication I/F 123 and to be unconnectable to the public network while the portable terminal 100 is logged in with the private user account.

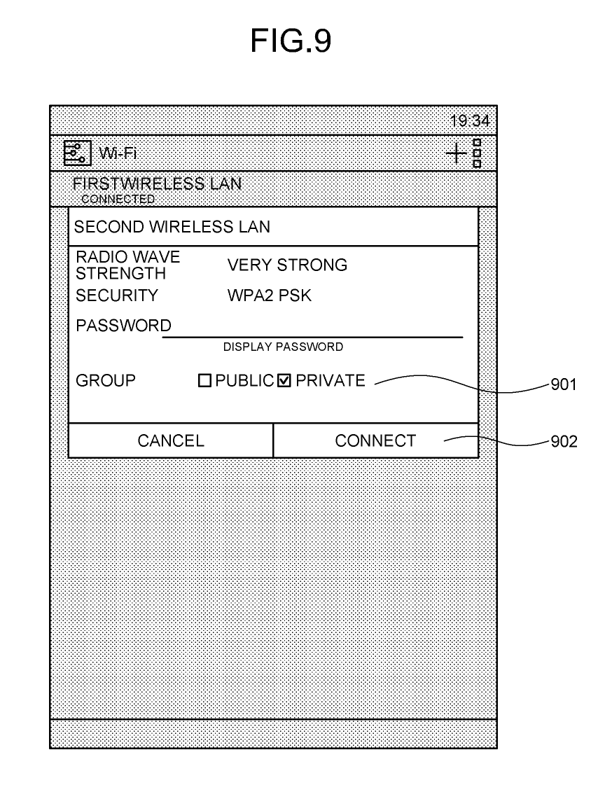

Described next is a method for setting a group for a network in the portable terminal 100 according to the present embodiment. First, the receiver 304 receives an operation for displaying a network connection setting screen. FIG. 9 is a diagram illustrating an example of the network connection setting screen displayed on the display 102a by the display controller 302 of the portable terminal 100 according to the present embodiment. The example of the network connection setting screen illustrated in FIG. 9 can receive, in addition to a general network setting, a setting of the group through a group setting item 901 for a network to connect. The receiver 304 receives the setting of the group (public or private) and then receives the pressing of a connect button 902. The controller 303 thus registers the setting in the network group list holding module 352. This can set a group for each network. In the example of the network connection setting screen, control may be performed so that “public” is checked forcefully when the user who is currently logged in is the public account, and that “private” is checked forcefully when the user who is currently logged in is the private account. An indication of error may be displayed without performing processing for connection when an attempt is made to connect to a network whose group is different from that of the user who is currently logged in.

The setting of the public network with the private account is thus inhibited from being performed, thereby further improving security.

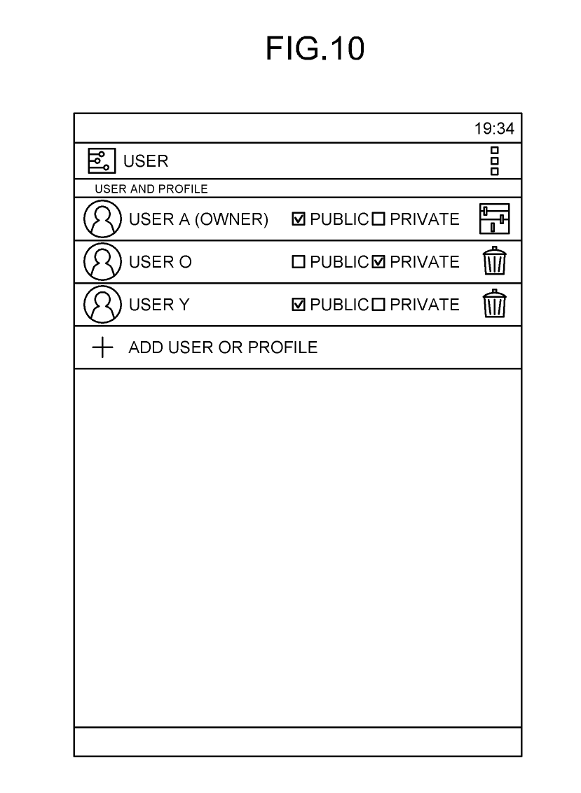

Described next is a method for setting a group for a user account in the portable terminal 100 according to the present embodiment. First, the receiver 304 receives an operation for displaying a user account setting screen. FIG. 10 is a diagram illustrating an example of the user account setting screen displayed on the display 102a by the display controller 302 of the portable terminal 100 according to the present embodiment. The example of the user account setting screen illustrated in FIG. 10 can receive a setting of a group for any user account. Upon receipt of the setting of the group (public or private) by the receiver 304, the controller 303 registers the setting in the user group list holding module 351. This can set a group for each user account.

The receiver 304 may receive from the user account setting screen an operation for switching to another user account. In this situation, a user account different in group from the currently connected network may be grayed out so as to be unable to be selected.

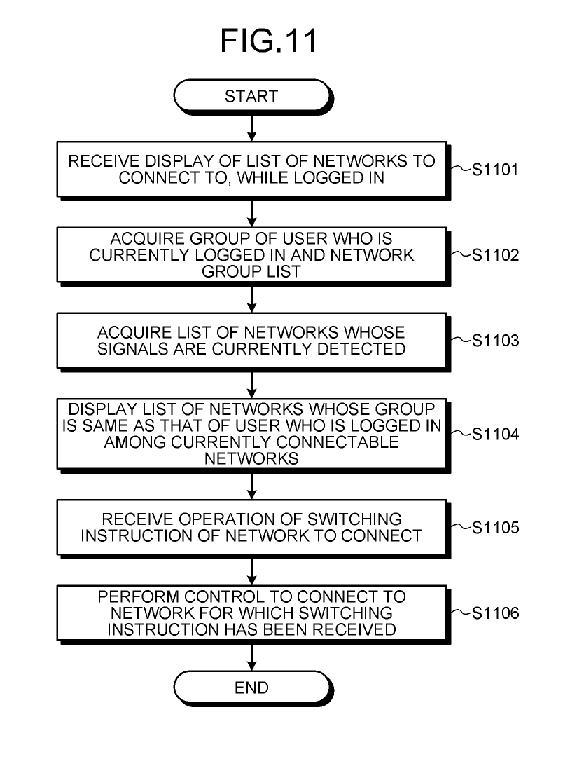

Described next is network switching processing in the portable terminal 100 in the present embodiment while a user has been logged in. FIG. 11 is a flowchart illustrating processing in the portable terminal 100 according to the present embodiment.

First, the receiver 304 receives an operation of the display of a list of connectable networks while a user has been logged in (S1101).

The controller 303 acquires the group of the user who has currently been logged in stored in the user group list holding module 351 and a network group list of the network group list holding module 352 (S1102).

The connection controller 301 acquires a list of networks whose signals are currently detected (that are currently connectable) (S1103). Based on the acquired network group list and the group of the user who has currently been logged in, the controller 303 determines a network whose group is the same as that of the user who has been currently logged in among the currently connectable networks. The controller 303 performs control so as not to connect to a network whose group is different from that of the user who has been currently logged in.

For that purpose, the display controller 302 displays a list of the networks whose group is the same as that of the user who has been logged in, among the currently connectable networks (S1104).

The receiver 304 receives an operation of a switching instruction of a network to connect from the listed networks (S1105). The connection controller 301 performs control to connect to the network for which the switching instruction has been received using the communication I/F 123 (S1106).

Because the present embodiment can select a network to connect from networks whose group is the same as that of the user account by performing the above control, connection to a network whose group is different from that of the user account can be inhibited.

Described next are variations of the case when the network is switched in the present embodiment. Described first is control performed when the network is switched when the portable terminal 100 is logged in with the public account. When the connection controller 301 connects to a public network (access point) or a public public line from no connection, no particular control is performed. When an attempt to switch from no connection to a private network (access point) or a private public line is made, the controller 303 performs control so as not to display, not to select, and not to automatically connect to the private network or the private public line. Similarly, also when an attempt to switch from the public network (access point) or the public public line to the private network (access point) or the private public line is made, the controller 303 performs control so as not to display, not to select, and not to automatically connect to the private network or the private public line.

While the portable terminal 100 has been logged in with the public account, when the public network (access point) or the public public line is switched to no connection, the controller 303 performs control so as to make the private account available (capable of logging in).

Described next is control performed when the network is switched while the portable terminal 100 has been logged in with the private account. When the connection controller 301 attempts to switch from no connection to the public network (access point) or the public public line, the controller 303 performs control so as not to display, not to select, and not to automatically connect to the public network or the public public line. As for switching from no connection to the private network (access point) or the private public line, no particular control is performed.

While the portable terminal 100 has been logged in with the private account, when switching from the private network (access point) or the private public line to no connection, the controller 303 performs control so as to make the public account available (capable of logging in).

While the portable terminal 100 has been logged in with the private account, when an attempt to switch from the private network (access point) or the private public line to the public network (access point) or the public public line is made, the controller 303 also performs control so as not to display, not to select, and not to automatically connect to the public network or the public public line.

Described next is control performed when the network is switched while the login screen is displayed. When connecting from no connection to the public network (access point) or the public public line, the controller 303 performs control so as not to be capable of logging in with the private account. When connecting from no connection to the private network (access point) or the private public line, the controller 303 performs control so as not to be capable of logging in with the public account.

When switching from the public network (access point) or the public public line to no connection, the controller 303 performs control so as to make the private account available (capable of logging in). When the public network (access point) or the public public line is switched to the private network (access point) or the private public line, the controller 303 performs control so as to make the private account available and so as not to be capable of logging in with the public account.

When the private network (access point) or the private public line is switched to no connection, the controller 303 performs control so as to make the public account available. When switching from the private network (access point) or the private public line to the public network (access point) or the public public line, the controller 303 performs control so as to make the public account available and so as not to be capable of logging in with the private account.

In this way, in the portable terminal 100 according to the present embodiment, while a certain user has been logged in, the controller 303 can perform control so as to enable a network whose group (attribute) is the same as that of the user to be connected and so as to disable a network whose group (attribute) is different from that of the user to be connected. This can improve security.

### Second Embodiment

The first embodiment describes an example in which a user is not permitted to connect to a network whose group is different from that of the user. However, so far as the correspondence relation between the user and the network is held, an embodiment is not limited to the method that performs control so as to be unconnectable to a network. A second embodiment describes an example in which when connecting to a network, a user whose group is different from that of the network is forcefully logged out.

Because the configuration of the portable terminal according to the second embodiment has a similar configuration to that of the first embodiment, its description will be omitted.

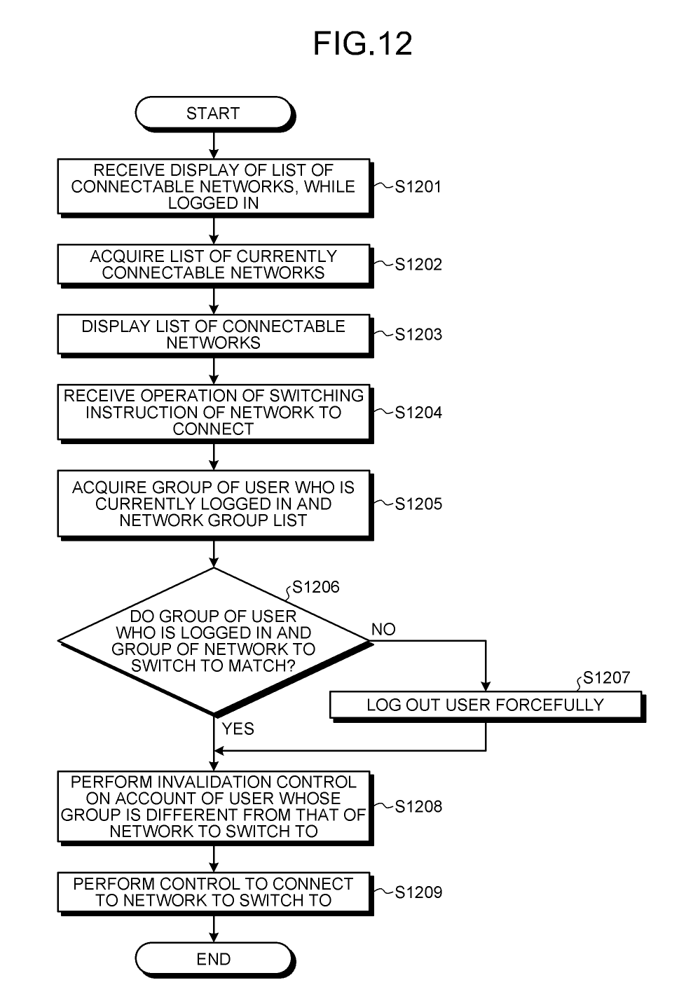

Described next is network switching processing of the portable terminal 100 according to the present embodiment while a user has been logged in. FIG. 12 is a flowchart illustrating the above processing in the portable terminal 100 according to the present embodiment.

First, the receiver 304 receives an operation of the display of a list of connectable networks while a user has been logged in (S1201).

The connection controller 301 acquires a list of networks whose signals are currently detected (that are currently connectable) (S1202).

The display controller 302 displays a list of the currently connectable networks (S1203). In this situation, the group (private or public) may be displayed for each network.

The receiver 304 receives an operation of a switching instruction of a network to connect from the listed networks (S1204).

The controller 303 acquires the group of the user who has currently be logged in stored in the user group list holding module 351 and a network group list of the network group list holding module 352 (S1205).

The controller 303 determines whether there is a match between the group of the user who has been currently logged in and the group of the network to be switched to (S1206). If it is determined that the group of the user who has been currently logged in and the group of the network to be switched to do not match (No at S1206), the controller 303 logs out the user forcefully (S1207).

If the controller 303 determines that the group of the user who has been currently logged in and the group of the network to be switched to match at S1206, (Yes at S1206), and following S1207, the controller 303 performs invalidation control so as to disable a login by the account of a user whose group is different from that of the network to be switched to (S1208). This can inhibit switching control to a user whose group is different from that of the network currently connected and a login by a user whose group is different from that of the network currently connected through the login screen.

The connection controller 301 performs control to connect to the network to switch to using the communication I/F 123 (S1209).

By the above processing, when receiving an operation for switching to a network whose group (attribute) is different from that of a user who has been currently logged in, the controller 303 performs control to log out the user. This can achieve network connection control corresponding to the account of the user.

The embodiments above performs control so as to hold the correspondence relation between the account of the user and the network to connect, thereby inhibiting an improper account from accessing a network currently connected and improving security.

The OS executed by the portable terminal 100 according to the embodiments above may be recorded and provided in a computer-readable recording medium such as a compact disc read only memory (CD-ROM), a flexible disk (FD), a compact disc recordable (CD-R), and a digital versatile disc (DVD), as an installable or executable file.

The OS executed by the portable terminal 100 according to the embodiments above may be stored in a computer connected to a network such as the Internet and provided by being downloaded via the network. Furthermore, the OS executed by the portable terminal 100 according to the embodiments above may be provided or distributed via a network such as the Internet.

The OS executed by the portable terminal 100 according to the embodiments above may be embedded and provided in a ROM, for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device for a first user and a second user configured to allow logging into an operating system, the electronic device comprising:
a communication controller configured to connect to one of a first network and a second network, and to communicate through a connected one of the first network and the second network; and
a controller configured to enable a login of the first user and to disable a login of the second user while the communication controller is connected to the first network, wherein
the controller is configured to enable a login of the second user and disable a login of the first user while the communication controller is connected to the second network, and
the controller is configured to set the electronic device to be usable by one of the first user logged in and the second user logged in.

2. The electronic device of claim 1, wherein the controller is configured to perform control to connect to the second network and not to connect to the first network by the communication controller while the second user is logged in.

3. The electronic device of claim 1, further comprising:
a receiver configured to receive an operation for switching to one of the first network and the second network to which the communication controller connects, wherein
the controller is configured to perform control to log out the second user when the receiver receives the operation for switching from the second network to the first network while the second user is logged in.

4. The electronic device of claim 1, further comprising:
a receiver configured to receive, before one of the first user and the second user logs in, a selection of one of the first network and the second network to which the communication controller connects, through the first network the communication is performed when the first user is logged in, through the second network the communication is performed when the second user is logged in, wherein
the communication controller is configured to connect to one of the first network and the second network for which the selection has been received by the receiver.

5. The electronic device of claim 1, wherein the receiver is configured to receive an attribute setting for determining whether each of the first user and the second user is connectable for each of the first network and the second network to which the communication controller is connectable, and receive the attribute setting for identifying a connectable one of the first network and the second network for each of accounts of the first user and the second user.

6. A method performed by an electronic device for a first user and a second user configured to allow logging into an operating system, the method comprising:
first enabling a login of the first user and first disabling a login of the second user while a communication controller is connected to a first network, the communication controller configured to connect to one of the first network and a second network, the communication controller communicating through a connected one of the first network and the second network;
second enabling a login of the second user and second disabling a login of the first user while the communication controller is connected to the second network; and
setting the electronic device to be usable by one of the first user logged in and the second user logged in.

7. The method of claim 6, further comprising performing control to connect to the second network and not to connect to the first network by the communication controller while the second user is logged in.

8. The method of claim 6, further comprising:
receiving an operation for switching to one of the first network and the second network to which the communication controller connects; and
performing control to log out the second user when the operation for switching from the second network to the first network is received at the receiving while the second user is logged in.

9. The method of claim 6, further comprising:
receiving, before any one of the first user and the second user logs in, a selection of one of the first network and the second network to which the communication controller connects, through the first network the communication is performed when the first user is logged in, through the second network the communication is performed when the second user is logged in, wherein
the communication controller is configured to connect to one of the first network and the second network for which the selection has been received at the receiving.

10. The method of claim 6, wherein the receiving comprises receiving an attribute setting for determining whether each of the first user and the second user is connectable for each of the first network and the second network to which the communication controller is connectable, and receive the attribute setting for identifying a connectable one of the first network and the second network for each of accounts of the first user and the second user.

11. A computer program product having a non-transitory computer readable medium including programmed instructions, wherein the instructions, when executed by a computer of an electronic device for a first user and a second user configured to allow logging into an operating system, cause the computer to perform:
first enabling a login of the first user and first disabling a login of the second user while a communication controller is connected to a first network, the communication controller configured to connect to one of the first network and a second network, the communication controller communicating through a connected one of the first network and the second network;
second enabling a login of the second user and second disabling a login of the first user while the communication controller is connected to the second network; and
setting the electronic device to be usable by one of the first user logged in and the second user logged in.

12. The computer program product of claim 11, further causes the computer to perform performing control to connect to the second network and not to connect to the first network by the communication controller while the second user is logged in.

13. The computer program product of claim 11, further causes the computer to perform:
receiving an operation for switching to one of the first network and the second network to which the communication controller connects; and
performing control to log out the second user when the operation for switching from the second network to the first network is received at the receiving while the second user is logged in.

14. The computer program product of claim 11, further causes the computer to perform:
receiving, before one of the first user and the second user logs in, a selection of one of the first network and the second network to which the communication controller connects, through the first network the communication is performed when the first user is logged in, through the second network the communication is performed when the second user is logged in, wherein
the communication controller is configured to connect to one of the first network and the second network for which the selection has been received at the receiving.

15. The method of claim 11, wherein the receiving comprises receiving an attribute setting for determining whether each of the first user and the second user is connectable for each of the first network and the second network to which the communication controller is connectable, and receive the attribute setting for identifying a connectable one of the first network and the second network for each of accounts of the first user and the second user.
